(19) United States
(12) Patent Application Publication
(10) Pub. No.: US 2009/0126514 A1
(43) Pub. Date: May 21, 2009

(54) Devices for collection and preparation of biological agents

(76) Inventors: Eric Gregory Burroughs, Morrisville, NC (US); Kenneth Scott Damer, Mount Wolf, PA (US); Phil Belgrader, Severna Park, MD (US); Benjamin Raab, Baltimore, MD (US)

Correspondence Address: ANDREWS KURTH LLP;Intellectual Property Department, Suite 1100, 1350 I Street, N.W., Washington, DC, 20005, US

(21) Appl. No.: 11/896,701

(22) Filed: Sep. 5, 2007

(51) Int. Cl. G01N 1/04; B01J 19/00

(52) U.S. Cl. 73/863.22; 422/68.1; 73/863.21; 73/863.23

(57) ABSTRACT

A sample collection system and method for airborne biological agents is disclosed. The sample collection system comprises a sample collection module that collects particles in an air flow and transfer the collected particles into a sampling fluid, and a sample preparation module that is responsible for accepting the sampling fluid from the sample collection module, continuously aggregating or concentrating the collected particles in the sampling fluid during the sampling process and recycling a particle-lean sampling fluid back to the collection module.

### FIELD OF INVENTION

This invention relates generally to detection of hazardous material and, in particular, to a sample collection and preparation system and method for airborne biological agents.

### BACKGROUND

There are many biological threats (toxin, virus, and bacteria for instance) that can be readily prepared and dispersed into the environment, either directly via airborne releases or indirectly via containers (such as letters, boxes, and luggage). Sampling the environment for the presence of various biological threats is thereby of utmost importance for the safety of the public and military personnel. Various systems have been developed to collect and analyze bioaerosol samples. Briefly, aerosols in air samples are captured, concentrated in a liquid (hydrosol) form, and subjected to further analysis.

Current aerosol-to-hydrosol (ATH) technologies rely upon various phenomena to separate particulate matter from air. However, they all endeavor to transfer (or capture) airborne particulate matter (inert, biological, and sometimes chemical) into a liquid medium. For example, some ATH technologies use the particle's inertia to capture it into a liquid media (e.g., inertial impactors and cyclonic separators), while others use electrostatic means to capture particulates (e.g., electrostatic separators).

These current ATH technologies typically operate in a “batch mode”. During the sampling period, the ATH collectors continuously recycle a batch of fluid over the collection surfaces. After a designated amount of time (typically on the order of a few hours), the ambient sampling equipment ceases to collect airborne particulates and the entire batch of fluid (with entrained particles) is transferred from the collector to the sample preparation/analysis equipment.

Current ATH collector technologies, however, are plagued by several systemic issues. First, the amount of materials collected over several hours can be substantial and can lead to a highly concentrated sample that could be quite viscous and contain clumps of materials. These highly concentrated samples can clog fluidic lines between modules, resulting in system failure. Second, the ability of the system to collect particulates degrades as the sample becomes more concentrated. Third, as the sampling fluid is continuously recycled and exposed to air, particulates within the fluid sample can become re-aerosolized, thereby reducing overall system aerosol collection performance.

The current systems can also have issues with maintaining the viability or integrity of the collected biological agents. Physical stresses on an organism, such as shearing, friction, collisions, etc., are know to compromise the viability of the organism and integrity of its DNA/RNA. Detection often relies upon the organism being viable (able to reproduce or multiple), or the DNA/RNA being capable of amplification. As the sampling fluid is being constantly circulated within current ATH collectors, the organism is constantly exposed to forces (mostly collection forces) that could compromise the viability of the organism or the integrity of its DNA/RNA. This can lead to ineffective detection of the collected biological agents.

Finally, the batch mode proceeds strictly in series, i.e., the collected sample is first processed by a sample preparation system and the processed sample is then sent to a sample analysis system for detection of biological agents. Each system must complete its processing before it can pass the liquid sample onto the next system. Operating in such a linear manner can prove to be time consuming, especially for the sample preparation.

Therefore, there still exists a need for sample collection systems that are resistant to clogging and are capable of collecting biological agents with high viability and integrity.

### SUMMARY OF THE INVENTION

One aspect of the present invention relates to a sample collection system for airborne biological agents. The sample collection system comprises a sample collection module and a sample preparation module. The sample collection module collects particles in an air flow and transfers the collected particles into a sampling fluid. The sample preparation module accepts the sampling fluid from the sample collection module, continuously aggregates or concentrates the collected particles in the sampling fluid during the sampling process and recycles a particle-lean sampling fluid back to the collection module.

Another aspect of the present invention relates to a method for collecting airborne biological agents. The method comprises the steps of separating particles from an air flow; collecting separated particles with a sampling fluid stream to produce a particle-rich sampling fluid stream; continuously aggregating the collected particles from the particle-rich sampling fluid stream by filtration or centrifugation to produce aggregated particles and a particle-lean sampling fluid stream; and recycling the particle-lean sampling fluid stream to the collecting step.

### BRIEF DESCRIPTION OF DRAWINGS

FIG. 1 is a block diagram showing an embodiment of the sample collection system of the present invention.

FIGS. 2A and 2B are schematic representations of normal flow filtration (FIG. 2A) and tangential flow filtration (FIG. 2B).

FIG. 3 is a schematic depicting an embodiment of a filtration unit using tangential flow filtration technology.

FIGS. 4-6 is are schematics depicting three embodiments of a sample preparation module.

FIG. 7 is a flow chart showing a method for collecting airborne biological agents.

### DETAILED DESCRIPTION OF THE INVENTION

In describing preferred embodiments of the present invention, specific terminology is employed for the sake of clarity. However, the invention is not intended to be limited to the specific terminology so selected. It is to be understood that each specific element includes all technical equivalents which operate in a similar manner to accomplish a similar purpose.

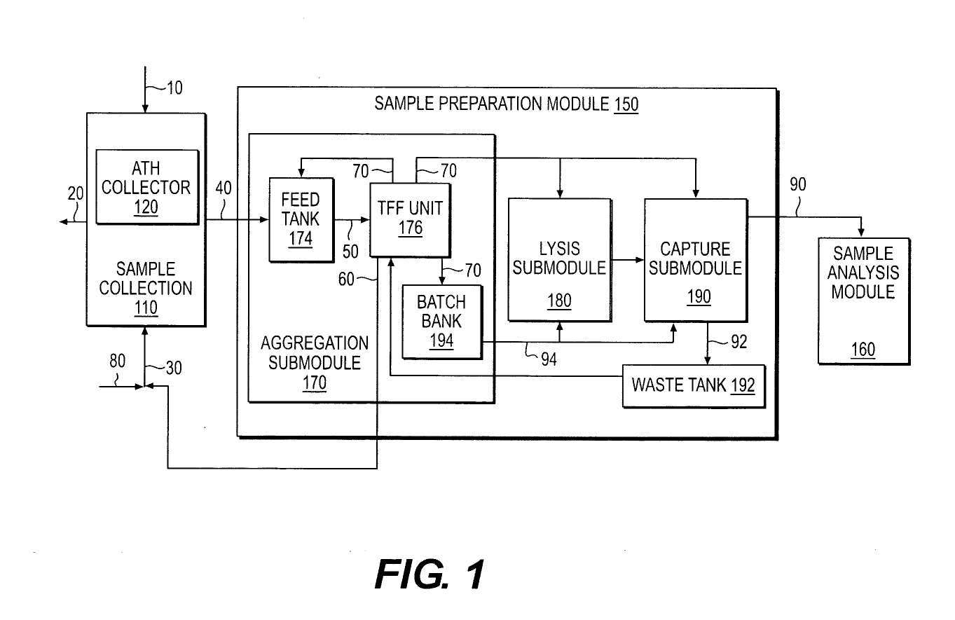

One aspect of the present invention relates to a sample collection system for airborne biological agents. In one embodiment, the sample collection system 100 (FIG. 1) comprises a sample collection module 110 that collects particles in an air flow and transfer the collected particles into a sampling fluid, and a sample preparation module 150 that is responsible for accepting the sampling fluid from the sample collection module 110, continuously aggregating or concentrating the collected particles in the sampling fluid during the sampling process and recycling a particle-lean sampling fluid back to the collection module.

Referring to FIG. 1, the sample collection module 110 comprises an aerosol-to-hydrosol (ATH) collector 120 that separates particles from an air flow during a sampling period and transfers the collected particles into a sampling fluid. The term “particles,” as used hereinafter, refers to any particulate matter in the ambient air, including but not limited to, aerosols, dusts, and airborne microorganisms such as fungi, bacteria and parasites. Current ATH technologies rely upon various phenomena to separate particles from air. For example, some ATH technologies use the particle's inertia to capture it into the sampling fluid, while others use electrostatic means to capture particles and then collect the particles with the sampling fluid. The sampling fluid can be any liquid media capable of maintaining the viability and integrity of the collected biological agents.

In one embodiment, the ATH collector 120 is a virtual impactor with a desired threshold size. Briefly, a jet of particle-laden air is accelerated toward a collection probe positioned downstream so that a small gap exists between the acceleration nozzle and the probe. A vacuum is applied to deflect a major portion of the air stream through the small gap. Particles larger than a preset threshold size, known as the cut point, have sufficient momentum so that they cross the deflected streamlines and enter the collection probe, whereas smaller particles follow the deflected air stream. Larger particles are removed from the collection probe by the minor portion of the air stream according to the magnitude of the vacuum applied to the minor portion.

In another embodiment, the ATH collector 120 is a regular inertial impactor. The particles are accelerated through a nozzle towards an impactor plate maintained at a fixed distance from the nozzle. The plate deflects the flow creating fluid streamlines around itself. Due to inertia, the larger particles are impacted (and collected) on a collector plate while the smaller particles follow the deflected streamlines.

In another embodiment, the ATH collector 120 is a cyclone separator. Cyclone separators typically comprise a settling chamber in the form of a vertical cylinder, so arranged that the particle laden air spirals round the cylinder to create centrifugal forces which throw the particles to the outside walls.

There are four commonly used cyclone separators: conventional cyclone, axial inlet and discharge cyclone, axial inlet peripheral discharge cyclone, and tangential inlet peripheral discharge cyclone, all of which are based on similar operating principles. In the conventional cyclone, the particle-laden air enters a cylinder tangentially, where it spins in a vortex as it proceeds down the cylinder. A cone section causes the vortex diameter to decrease until the air reverses on itself and spins up the center to the outlet pipe or vortex finder. A cone causes flow reversal to occur sooner and makes the cyclone more compact. Particles in the air are centrifuged toward the wall and collected by inertial impingement. The collected particles flows down in the gas boundary layer to the cone apex where it is discharged through an air lock or into a particle hopper serving one or more parallel cyclones.

The axial inlet and discharge cyclone has a smaller diameter than conventional cyclone. Because of its smaller diameter, an axial inlet and discharge cyclone has higher collection efficiency but low air capacity. In the tangential inlet peripheral discharge and the axial inlet peripheral discharge cyclones, particles are not completely removed from the air stream but are concentrated into about 10% of the total flow. The collection efficiency is increased by removing the particles in airborne form and reducing its entrainment losses which occur at the cone apex.

In another embodiment, the ATH collector 120 is an electrostatic separator. Particles or aerosols that enter the collector are charged (either positively or negatively) by an electrode and then collected on an oppositely charged plate that has a fluid stream constantly running over it.

Examples of biological agents include, but are not limited to, bacteria, viruses, parasites and biotoxins. Examples of bacteria include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chiamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachiamydia, Pasteurella, Pediococcus, Peptococcus, Peptostreptococcus, Photobacterium, Photorhabdus, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Staphylococcus, Stenotrophomonas, Stomatococcus, Streptobacillus, Streptococcus, Streptomyces, Succinivibrio, Sutterella, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholerae, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chiamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof.

Examples of viruses include, but are not limited to, Herpes simplex virus type-1, Herpes simplex virus type-2, Cytomegalovirus, Epstein-Barr virus, Varicella-zoster virus, Human herpesvirus 6, Human herpesvirus 7, Human herpesvirus 8, Variola virus, Vesicular stomatitis virus, Hepatitis A virus, Hepatitis B virus, Hepatitis C virus, Hepatitis D virus, Hepatitis E virus, Rhinovirus, Coronavirus, Influenza virus A, Influenza virus B, Measles virus, Polyomavirus, Human Papilomavirus, Respiratory syncytial virus, Adenovirus, Coxsackie virus, Dengue virus, Mumps virus, Poliovirus, Rabies virus, Rous sarcoma virus, Yellow fever virus, Ebola virus, Marburg virus, Lassa fever virus, Eastern Equine Encephalitis virus, Japanese Encephalitis virus, St. Louis Encephalitis virus, Murray Valley fever virus, West Nile virus, Rift Valley fever virus, Rotavirus A, Rotavirus B, Rotavirus C, Sindbis virus, Simian Immunodeficiency cirus, Human T-cell Leukemia virus type-I, Hantavirus, Rubella virus, Simian immunodeficiency virus, Human Immunodeficiency virus type-1, Vaccinia virus, SARS virus, and Human Immunodeficiency virus type-2, or any strain or variant thereof.

Examples of parasites include, but are not limited to, Toxoplasma gondii, Plasmodium falciparum, Plasmodium vivax, Plasmodium malariae, other Plasmodium species, Trypanosoma brucei, Trypanosoma cruzi, Leishmania major, other Leishmania species, Schistosoma mansoni, other Schistosoma species, and Entamoeba histolytica, or any strain or variant thereof.

Examples of biotoxins include, but are not limited to, Staphylococcal enterotoxin B (SEB), racin, botulinum toxins, and the trichothecene mycotoxins.

Referring again to FIG. 1, an air sample stream 10 enters the ATH collector 120 and exits the ATH collector 120 as an flow-through air stream 20. A sampling fluid stream 30 enters the ATH collector 120 and exits the ATH collector 120 as an particle-rich sampling fluid stream 40. The particle-rich sampling fluid stream 40, which contains particles collected from the air stream 10, is transferred to the sample preparation module 150 for further processing.

The sample preparation module 150 prepares the collected particles for analysis in the sample analysis module 160. In one embodiment, the sample preparation module 150 comprises an aggregation submodule 170 that concentrates or aggregates the particles in the particle-rich sampling fluid stream 40 using filtration or centrifugation technology and recycle a particle-lean sampling fluid stream 60 back to the sample collection module 110. Filtration and centrifugation technologies have been widely employed in biotech and engineering fields as a method of separating, concentrating, and collecting inert and biological material of interest.

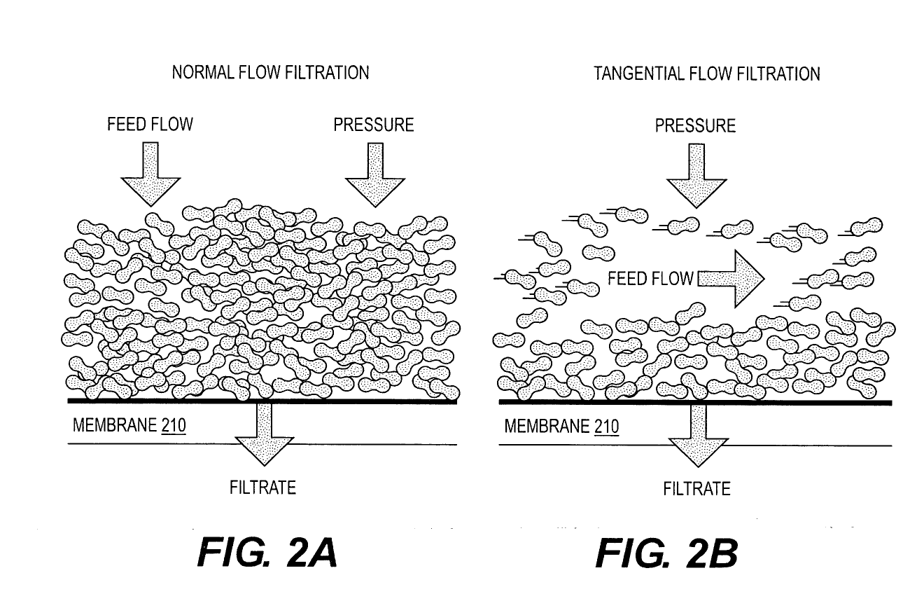

In a preferred embodiment, the aggregation submodule 170 employs a filtration technology. As shown in FIGS. 2A and 2B, there are two distinct classifications of filtration, namely geometrically normal flow filtration (FIG. 2A) and tangential flow filtration (FIG. 2B).

In normal flow filtration (NFF), the sampling fluid and particulates flow normal to a filter membrane 210 having desired pore sizes. Liquid and particles smaller than membrane pore sizes pass through the filter membrane 210 while particles too large to pass through the membrane 210 are retained on the surface of the membrane 210.

In tangential flow filtration (TFF), the sampling fluid and particles flow tangentially across the surface of the filter membrane 210. The difference in pressure on the two sides of the filter membrane 210 forces a portion of the sampling fluid and particles smaller than membrane pore sizes through the filter membrane 210. Instead of collecting on the surface of the filter membrane 210, particles too large to pass through the filter membrane 210 are swept along the surface of the filter membrane 210 by the sampling fluid. In other words, the particle-containing sampling fluid flows parallel to the filter membrane 210. Large particles are retained and do not build up on the surface of the filter membrane 210 as the flow forces the particles along. The large particles do not collect on the surface of the filter membrane 210.

The filter membrane 210 typically comprises a microporous material capable of trapping the biological agent of interest in a liquid sample. The term “microporous material,” as used herein, is any material having a plurality of pores, holes, and/or channels. The microporous material permits the flow of liquid through or into the material. The microporous material generally possesses a high concentration of small, uniform holes or pores of sub-micron dimensions. The microporous material can be hydrophilic to permit the rapid flow of water through the material. It is also desirable that the microporous material also possess good mechanical strength for easy handling and has a low non-specific binding. Microporous materials include any of the composites and modified-microporous materials discussed below.

The micropores can have diameters ranging in size from about 0.001 micron to about 10 microns. For very large analytes, such as intact bacteria, cells, dust, etc. larger pore sizes are contemplated. Larger pore sizes are also less prone to plugging with impurities generally found in some samples. Typically, the pore size is selected based on the size of the materials to be collected.

The microporous material can be composed of any material that has a high concentration of small, uniform holes or pores or that can be converted to such a material. Examples of such materials include, but are not limited to, inorganic materials, polymers, and the like. In one embodiment, the microporous material is a ceramic, a metal, carbon, glass, a metal oxide, or a combination thereof. In another embodiment, the microporous material includes a track etch material, an inorganic electrochemically formed material, and the like. The phrase “inorganic electrochemically formed material” is defined herein as a material that is formed by the electroconversion of a metal to a metal oxide. The phrase “track etch material” is defined herein as a material that is formed with the use of ionizing radiation on a polymer membrane to produce holes in the material. Such materials are commercially available. When the microporous material is a metal oxide, the metal oxide includes aluminum oxide, zirconium oxide, titanium oxide, a zeolite, or a combination thereof. The metal oxide can also contain one or more metal salts in varying amounts. For example, aluminum salts such as aluminum phosphate, aluminum chloride, or aluminum sulfate can be part of the microporous material.

In another embodiment, the microporous material is an inorganic electroformed metal oxide. Such ceramic membranes are available from Whatman, Inc. and distributed under the trade names Anopore™ and Anodisc™. Anopore membranes have a honeycomb type structure with each pore approximately 0.2 micron in diameter by 50 microns long. The Anopore membranes are composed of predominantly aluminum oxide with a small amount (5-10%) of aluminum phosphate. In another embodiment, the microporous material can be aluminum or titanium that has been anodized. Anodization is a technique known in the art that is used to produce an oxide layer on the surface of the aluminum or titanium.

The microporous material can also be chemically modified to enhance or reduce surface retention of the biological agents of interest. For example, if the biological agent is negatively charged, the microporous material can be treated to have a positive or negative charge so that the charged biological agent of interest is attracted or repelled, respectively, through ionic forces. In one embodiment, the microporous material can be pretreated with silanization reagents including, but not limited to, aminopropyltrimethoxysilane (APS), ethylenediaminopropyltrimethoxysilane (EDAPS), or other amino silane reagents to impart a slight positive surface charge. In another embodiment, the microporous material is pretreated with polymer materials, including but not limited to polylysine, to impart a slight surface charge. Additionally, the microporous material can be modified with neutral reagents such as a diol, an example of which is acid hydrolyzed glycidoxypropyltrimethoxysilane (GOPS), to vary biolgical agent retention.

In one embodiment, the aggregation submodule 170 of the present invention uses TFF technology to concentrate or aggregate particles in the particle-rich sampling fluid stream 40. Table 1 provides a list of typical components that would be retained by subdivisions of the TFF process. Filter membranes for TFF are available to process varying sizes of particles and need to be replaced only on a limited basis. TFF systems can be designed as scalable cartridges/tubes that are small in size and have separation efficiencies that are close to 100%. One skilled in the art would understand that the aggregation submodule 170 may also use NFF technology or centrifugation technology to concentrate or aggregate particles in the particle-rich sampling fluid stream 40. In one embodiment, the aggregation submodule 170 comprises a NFF unit. In another embodiment, the aggregation submodule 170 comprises a centrifugation unit.

TABLE 1
Subdivisions of tangential flow filtration process

| | | | High- | | |
|---|---|---|---|---|---|
| | | Virus | Performance | Ultrafiltration | Nanofiltration/ |
| | Microfiltration | Filtration | Filtration | TFF | Reserve Osmosis |
| Components | Intact cells | Viruses | Proteins | Proteins | Antibiotics |
| retained | Cell debris | | | | Sugars |
| by membrane | | | | | Salts |
| Components | Colloidal material | Proteins | Proteins | Small Peptides | (Salts)P |
| passed | Viruses | Salts | Salts | Salts | Water |
| through membrane | Proteins | | | | |
| | Salts | | | | |
| Approximate | 0.05 μm-1 μm | 100 kD-0.05 μm | 10 kD-300 kD | 1 kD-1000 kD | <1 kD |
| membrane cutoff | | | | | |
| range | | | | | |

Referring again to FIG. 1, the aggregation submodule 170 comprises a feed tank 174 and a TFF unit 176. The particle-rich sampling fluid stream 40 from the sample collection module 110 is pooled in the feed tank 174 and then enters the TFF unit 176 as a feed stream 50. The filtrate (i.e., materials that pass the filter membrane) exits the aggregation submodule 170 as a particle-lean filtrate stream 60, which is re-circulated to the ATH collector 120. The filtrand (i.e., materials that are retained by the filter membrane), which now has a higher concentration of collected particles than that of the feed stream 50, exits the TFF unit 176 as the particle-laden filtrand stream 70. Sampling fluid lost during the filtration process can be compensated, if needed, by a make-up sampling fluid stream 80.

The filtrand stream 70 can be sent to other submodules (e.g., lysis submodule 180 or capture submodule 190) for continuous sample preparation or directly to the analysis module 160 for detection of biological agents. Alternatively, a portion of the filtrand steam 70 may be drawn for sample preparation or analysis, while the rest of the filtrand stream 70 is recycled back to the feed tank 174. Another option is to recycle all of the filtrand stream 70 back to the feed tank 174. After a predetermined period of time, the entire fluid sample in the feed tank 174 is drawn for analysis.

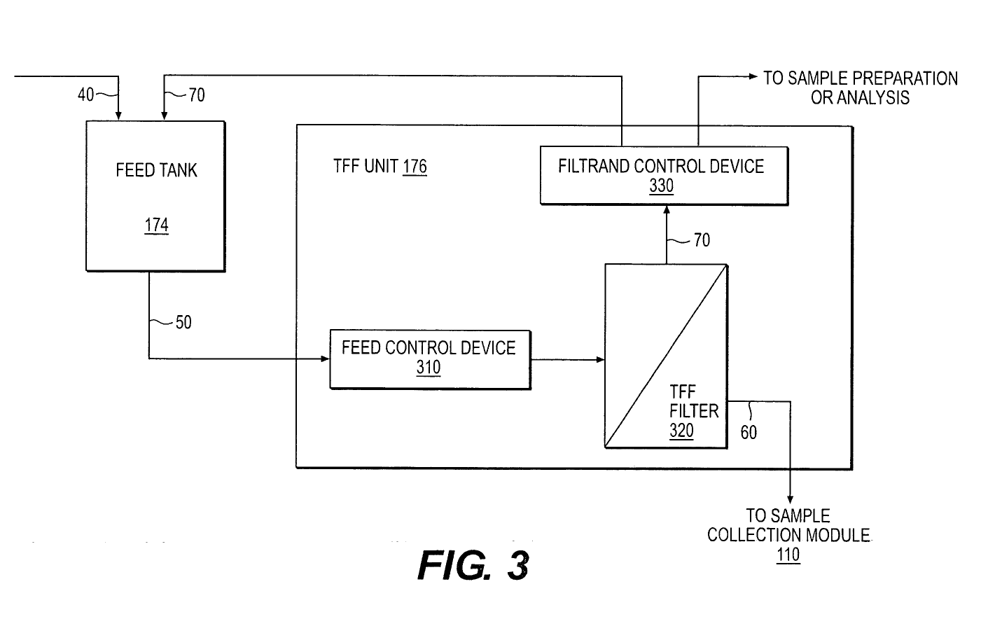

FIG. 3 depicts in more detail an embodiment of the TFF unit 176. In this embodiment, the particle-rich sampling fluid stream 40 from the collection module 110 is pooled in the feed tank 174. A feed control device 310 of the TFF unit 176 draws the fluid from the feed tank 174 as the feed stream 50 and delivers the feed stream 50 to a TFF filter 320 at desired flow rate and pressure. The particle-lean filtrate stream 60 is recycled back to the ATH collector 120. Depending on the mode of operation, a filtrand control device 330 would send the particle-laden filtrand stream 70 to either the feed tank 174 for recirculation through the TFF unit or other submodules for processing. One skilled in the art would understand that the feed control device 310 and filtrand control device 330 may be composed of commonly used fluid control apparatuses such as pumps, valves, pressure meters, and combinations thereof.

The system depicted in FIG. 3 can be used to further concentrate the particle-rich sampling fluid in the feed tank 174 to a desired liquid sample volume. For example, when a sample is taken for analysis, operating the TFF unit 176 the incoming particle-rich sampling fluid stream 40 reduces the fluid volume inside the feed tank 174. The particle-laden filtrand stream 70 is continually recycled past the TFF filter 320 while the filtrate stream 60 is temporarily placed in a storage tank. The particle-laden filtrand stream 70 is recycled to the feed tank 174 until a desired sample volume is achieved. When reducing the sample volume, a second smaller TFF cartridge/tube might have to be used to maintain the proper flow rate past the TFF filter 320.

The integration of a TFF system with an ATH collector significantly reduces some of the deficiencies (both systemic and biological) related to ATH collectors. From a biological perspective, by removing collected material from the continuous sampling process, the collected biomaterial will not be exposed to collection-related stresses that can compromise the viability and integrity of the collected organisms/biomaterials. In addition, studies have shown that aggregation of biomaterial can enhance the viability of collected organisms.

From a system perspective, processing clean, filtered fluid through the ATH collector enhances system performance and reliability. System reliability is enhanced as collected particles are removed from the active sampling stream, thereby greatly reducing the risk of clogging sensitive collection equipment. Employing TFF also has the potential to increase collection performance as degradation in collection efficiency generally occurs with increasing concentration of collected material in the liquid sampling medium. In addition, removing collected material from the collector fluid eliminates the possibility of collected material becoming re-aerosolized, thereby achieving perfect retention efficiency and boosting the overall collection efficiency of the system. Lastly, the functionality and applicability of aerosol-to-hydrosol collection technology can be extended as TFF enables concentrated liquid samples to be sent to analysis equipment in continuous and semi-continuous mode, while retaining the ability to operate in batch mode.

The sample preparation module 150 often utilizes cell lysis mechanisms (chemical or physical) and/or capture mechanisms (such as capture probes on the surface of a plate, channel, or bead) to prepare the collected particles for analysis in the sample analysis module 160. The lysis mechanism may be separated from the capture mechanism. For example, preparation of a biological agent for DNA or RNA detection typically involves both cell lysis and capture of cellular DNA or RNA, while toxin detection typically only involves capture of the toxin molecules. The lysis step, when applied to toxins, can severely reduce the efficiency of toxin detection.

Referring again to FIG. 1, the sample preparation module 150 may further comprises a lysis submodule 180 and a capture submodule 190. The lysis submodule 180 may use a variety of cell lysis technologies to lyse the collected biological agents, which are often present in forms of spores, bacteria or parasite cells, and virus particles. Cell lysis typically refers to opening a cell membrane to allow the intracellular material to come out. Cell lysis can be achieved by chemical, mechanical or physical means. The type of cells to be lysed often necessitates certain methods or combinations of methods.

Chemical techniques use enzymes or detergents to dissolve the cell walls, and are usually followed by sonication, homogenization, vigorous pipetting or vortexing in a lysis solution, such as a NaOH-SDS lysis solution. Mechanical lysis may be accomplished with a mortar and pestle, bead mill, press, blender, grinder, or nozzle. Physical lysis may be accomplished with ultrasonic waves or electrical fields.

Ultrasonic lysing operates on the basis of generating intense sonic pressure waves in a liquid medium in which the cellular material of interest is suspended. The pressure waves are transferred to the medium with a probe or membrane, and cause the formation of microbubbles that grow and collapse violently, generating shock waves that break cell membranes. Pulsed electric fields have been used for the destruction of cell structures. For example, Tai et al. describes a device that lyses cells using pulsed electric fields at a low voltage (U.S. Pat. Nos. 6,534,295 and 6,287,831). In addition, cells may also be lysed by other physical means such as freeze-thaw cycles.

The capture module 190 selectively captures a subpopulation of molecules that can be used to identify a biological agent in the sampling fluid or cell lysate. For example, DNA or RNA molecules may be captured from the cell lysate and amplified for the presence of sequences specific to a biological agent. Certain proteins can also be used as markers of biological agents. Accordingly, a subpopulation of proteins may be captured and screened for the presence of these markers. If the biological agent of interest is a protein molecule itself, such as a biotoxin, the capture module 190 may be designed to capture the biological agent. One skilled in art would understand that a variety of capture mechanisms can be employed. In one embodiment, the capture module 190 comprises capture probes immobilized on a solid support, such as the surface of a plate, channel, or bead. Examples of capture probes include, but are not limited to, peptides and oligonucleotides.

The sample preparation module 150 is capable of operating in several different modes, including a batch preparation mode, a continuous preparation mode, and a semi-continuous preparation mode. In the batch preparation mode, the ATH collector 120 continuously recycle a batch of fluid over the collection surfaces. After a designated amount of time, the ambient sampling equipment ceases to collect airborne particulates and the entire batch of particle-rich sampling fluid 40 is transferred from the ATH collector 120 to the sample preparation module 150 and is processed in various submodules strictly in series. i

In the continuous preparation mode, a continuous stream of the particle-rich sampling fluid 40 is supplied to the aggregation submodule 170. The sampling fluid is pooled in the feed tank 174 and continuously processed by the TFF unit 176. A continuous stream of filtrand 70 is sent from the TFF unit 176 to the lysis submodule 180 and/or the capture submodule 190. The captured material, such as a biological agent (e.g., a biotoxin), or a component of a biological agent (e.g., DNA or RNA from a biological agent), is sent to the sample analysis module 160 as an continuous analyte stream 90. An waste stream 92, which contains cellular and inert debris and potentially chemicals (if chemical lysis is used) is stored in a waste tank 192. In one embodiment, the waste stream 92 is transferred back to the TFF Unit 176, which removes the debris in the waste stream 92 and recycles the sampling fluid back to the sample collection module 110.

If the biological agent of interest is a toxin, the filtrand stream 70 may bypass the lysis submodule 180 and directly enters the capture submodule 190. If the toxin is to be tagged with expensive markers before being sent to the capture module, the filtration unit 176 can operate in an aggregation (or batch) mode to reduce consumables. The pre-collection tagging process is relatively quick, so a toxin preparation system would not be a time consuming or rate-limiting step. Alternatively, the toxin can be captured in the capture submodule 190 by continuously flowing over a packed bed or through a channel with capture Abs immobilized on the surface. At the end of the collection cycle, the captured toxin is eluted from the capture module and sent to the analysis module 160 as the analyte stream 90.

The lysis and capture processes typically require a discrete residence time to operate efficiently. If this residence time is longer than practicable for designing a continuous flow system, a semi-continuous sample preparation approach can be employed. In this approach, the particle-rich sampling fluid stream 40 enters the aggregation submodule 170 as a continuous fluid stream. However, instead of continuously flowing the filtrand stream 70 through the lysis submodule 180 and/or capture submodule 190, the aggregation submodule 170 would aggregate a small volume of filtrand 70 that would be stored in a batch bank 194 and release for processing a series of small batches 94. Each small batch would then be held in the various preparation submodules to assure efficient processing. The volume of the filtrand aggregated and the sizing of the preparation submodule module equipment would be based on residence time requirements. If properly implemented, at the end of the sampling period, both the semi-continuous and continuous approach would have the same small sample volume remaining to be processed. In this manner, the semi-continuous and continuous approaches would have very similar performance. In one embodiment, the small batches of the filtrand are stored in a batch tank 194 before being sent to the lysis submodule 180 or capture submodule 190.

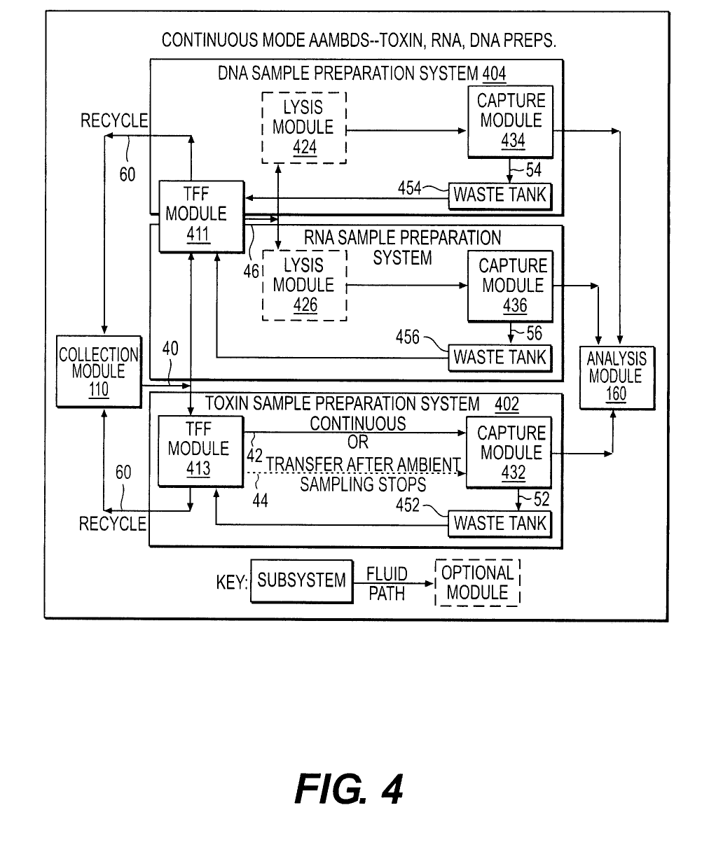

In many scenarios, a biological agent detection system is designed to detect RNA, DNA, and toxins in the ambient environment. This would represent the most complicated scenario for the continuous preparation approach, as each target class (RNA, DNA or toxin) would potentially require separate preparation processes. FIGS. 4, 5, and 6 provide three embodiments of the sample preparation module 150 that is capable of providing DNA, RNA and toxin preparations as continuous analyte streams.

Referring now to FIG. 4, the continuous particle-rich sampling fluid stream 40 from the collection module 110 is divided and sent to respective TFF submodules 411 and 413 for nucleic acid and toxin preparations processes. In a toxin sample preparation system 402, the toxin TFF submodule 413 either aggregates material from the particle-rich sampling fluid stream 40 and releases the entire batch after the ambient sampling period (filtrand stream 42), or operates in a continuous collection manner (filtrand stream 44) through capture submodule 432. The waste stream 52 from the capture submodule 432 is stored in waste tank 452 and, optionally, is recycled to the toxin TFF submodule 413.

The nucleic acid TFF submodule 411 provides a continuous filtrand stream 46 which is directed to a DNA sample preparation subsystem 404 or a RNA sample preparation subsystem 406, or both. In the DNA sample preparation subsystem 404, the filtrand 415 is processed by a lysis submodule 424 and a DNA capture submodule 434. In the RNA sample preparation subsystem 406, the filtrand 415 is processed by a lysis submodule 426 and a RNA capture submodule 436. The waste streams 54 and 56 from the capture submodules 434 and 436, respectively, are stored in waste tanks 454 and 456. Optionally, the waste streams 54 and 56 are recycled to the nucleic acid TFF submodule 411.

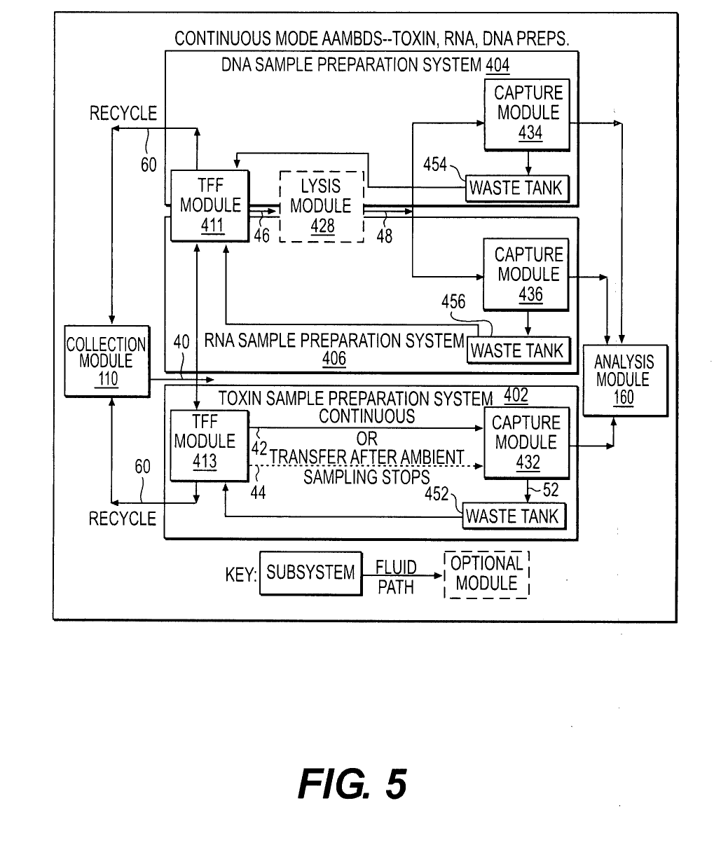

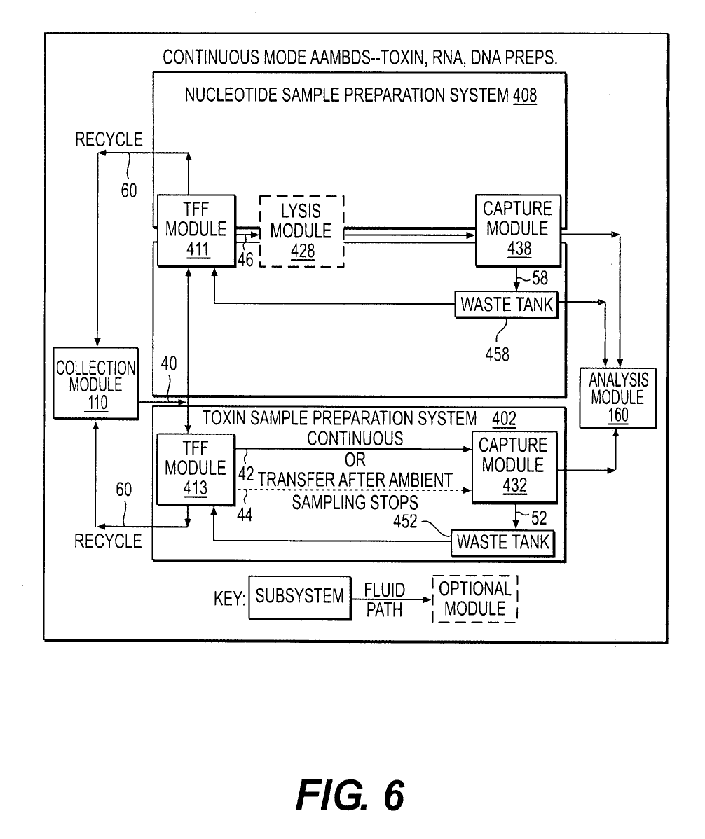

FIG. 5 depicts another embodiment of the sample preparation module. In this embodiment, the filtrand 46 is processed by a single lysis module 428. The lysate stream 48 is then directed to the DNA capture submodule 434, RNA capture submodule 436, or both. In another embodiment (FIG. 6), the DNA sample preparation subsystem 404 and the RNA sample preparation subsystem 406 are combined into a nucleotide preparation subsystem 408. Both DNA and RNA samples are prepared with the same lysis submodule 456 and capture submodule 458.

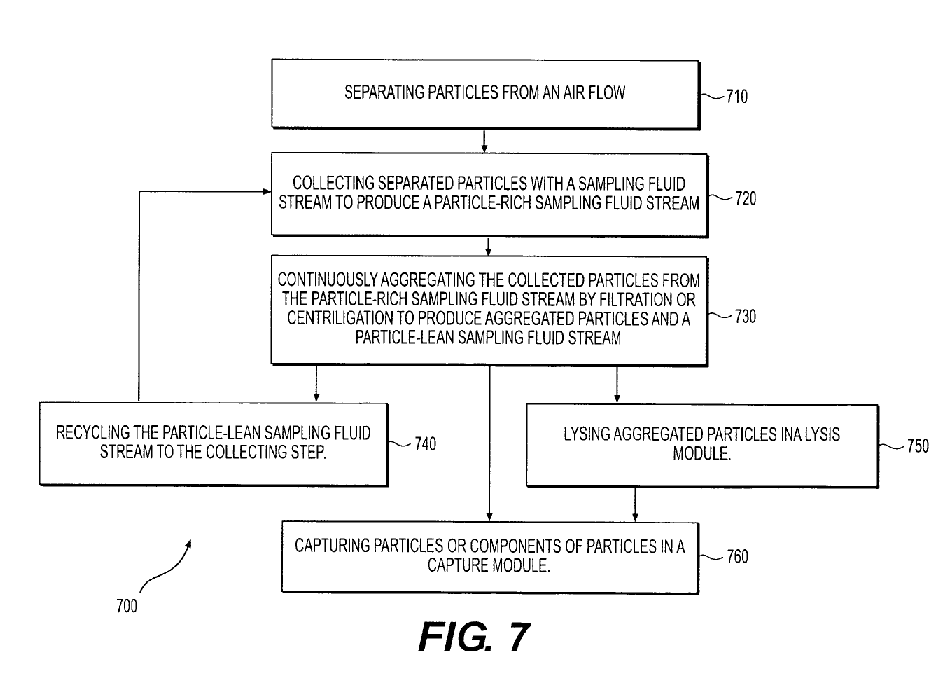

Another aspect of the present invention relates to a method for collecting airborne biological agents. In one embodiment, the method 700 (FIG. 7) comprises the steps of separating (710) particles from an air flow; collecting (720) separated particles with a sampling fluid stream to produce a particle-rich sampling fluid stream; continuously aggregating (730) the collected particles from the particle-rich sampling fluid stream by filtration or centrifugation to produce aggregated particles and a particle-lean sampling fluid stream; and recycling (740) the particle-lean sampling fluid stream to the collecting step.

In one embodiment, the aggregating step is carried out by tangential flow filtration that generates an aggregated particle stream.

In another embodiment, the method further comprises the step of capturing (760) particles or components of particles from the aggregated particles in a capture module.

In another embodiment, the method further comprises the step of lysing (750) the aggregated particles prior to said capturing step in a lysis module.

In another embodiment, the aggregated particle stream from the tangential flow filtration flows through the lysis module and/or the capture module in a continuous manner

In another embodiment, the aggregated particles in the aggregated particle stream are stored in small batches, wherein each batch is processed in the lysis module and/or the capture module in series.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

What is claimed is:

1. A sample collection system for biological agents, comprising:
a collection module comprising an aerosol-to-hydrosol (ATH) collector that separates particles from an air flow during a sampling process, collects separated particles with a sampling fluid, and produces a particle-rich sampling fluid stream; and
a sample preparation module that continuously aggregates collected particles in the particle-rich sampling liquid during the sampling process and recycles a particle-lean sampling fluid back to the collection module,
wherein said collected particles are analyzed for the presence of biological agents.

2. The sample collection system of claim 1, wherein said ATH collector is selected from the group consisting of virtual impactors, regular inertial impactors, cyclone separators, and electrostatic separators.

3. The sample collection system of claim 1, wherein said sample preparation module comprises:
an aggregation submodule comprising a filtration unit or a centrifugation unit, said filtration unit or said centrifugation unit separates particles in the particle-rich sampling fluid from said sampling fluid.

4. The sample collection system of claim 3, wherein said filtration unit is a tangential flow filtration unit comprising:
a feed tank that receives the particle-rich sampling fluid stream from said collection module; and
a tangential flow filter.

5. The sample collection system of claim 4, wherein said tangential flow filtration unit further comprises:
a feed pressure control device that controls pressure in a liquid stream flowing from said feed tank into said tangential flow filter.

6. The sample collection system of claim 5, wherein said tangential flow filtration unit further comprises:
a retentate pressure control device that controls pressure in a retentate stream that flows from said tangential flow filter to said feed tank.

7. The sample collection system of claim 3, wherein said filtration unit is a normal flow filtration unit.

8. The sample collection system of claim 3, wherein said sample preparation module further comprises a capture submodule that captures a subpopulation of collected particles, or components of collected particles, for the identification of a biological agent.

9. The sample collection system of claim 8, wherein said sample preparation module further comprises a lysis submodule that lyses aggregated particles by said aggregation submodule.

10. The sample collection system of claim 9, wherein said sample preparation module comprises a first lysis submodule for detection of DNA molecules, and a second lysis submodule for detection of RNA molecules.

11. The sample collection system of claim 3, wherein said sample preparation module comprises a first capture submodule for DNA molecules, a second capture submodule for RNA molecules, and a third capture submodule for protein molecules.

12. The sample collection system of claim 8, wherein said sample preparation module delivers prepared samples to an analysis module in a continuous manner, wherein said prepared samples comprise materials eluted from said capture module.

13. The sample collection system of claim 8, wherein particles separated from said particle-rich sampling fluid by said aggregation submodule are stored in batches and delivered to said capturing submodule in batches.

14. A method for collecting biological agents from an air flow, comprising:
separating particles from said air flow;
collecting separated particles with a sampling fluid stream to produce a particle-rich sampling fluid stream;
continuously aggregating the collected particles from said particle-rich sampling fluid stream by filtration or centrifugation to produce aggregated particles and a particle-lean sampling fluid stream; and
recycling said particle-lean sampling fluid stream to said collecting step.

15. The method of claim 14, wherein said aggregating step is carried out by tangential flow filtration that generates an aggregated particle stream.

16. The method of claim 15, further comprising:
continuously capturing particles or components of particles from said aggregated particle stream for identification of a biological agent.

17. The method of claim 16, further comprising:
continuously lysing particles in said aggregated particle stream prior to said capturing step.

18. The method of claim 15, wherein aggregated particles in said aggregated particle stream are stored in batches, wherein each batch is analyzed for the presence of biological agents.

19. The method of claim 18, where aggregated particles in each batch are lysed prior to analysis of biological agents.

20. The method of claim 18, wherein particles or components of particles from said aggregated particles in each batch are captured and isolated for identification of a biological agent.
